(19) United States
(12) Patent Application Publication
(10) Pub. No.: US 2025/0293466 A1
(43) Pub. Date: Sep. 18, 2025

(54) VEHICLE CONNECTOR

(71) Applicant: QIDONG LINKCONN ELECTRONICS CO., LTD., Nantong (CN)

(72) Inventors: Chuan LU, Nantong (CN); Yanfei DAI, Nantong (CN)

(21) Appl. No.: 19/226,182

(22) Filed: Jun. 3, 2025

Related U.S. Application Data
(63) Continuation of application No. PCT/CN2023/129208, filed on Nov. 2, 2023.

(30) Foreign Application Priority Data
Dec. 6, 2022 (CN) 202211561261.1
Dec. 6, 2022 (CN) 202223271258.4
Dec. 6, 2022 (CN) 202223271994.X
Apr. 13, 2023 (CN) 202310397356.2
Apr. 13, 2023 (CN) 202320825826.6
Apr. 13, 2023 (CN) 202320838561.3

(51) Int. Cl. H01R 13/6581; H01R 13/405; H01R 13/631

(52) U.S. Cl. CPC H01R 13/6581; H01R 13/405; H01R 13/631; H01R 2201/26

(57) ABSTRACT

A vehicle connector includes a mounting body, a mating body and a plurality of terminal portions fixed on the mounting body; the mating portion has a mating cavity that runs through front and back, each terminal portion includes an insulative housing and a conductive terminal disposed in the insulative housing, the conductive terminal defines a retaining portion fixed in the insulative housing and a contacting portion extending from the retaining portion and protruding out of the insulative housing; wherein the mounting body defines a base portion for fixing the mating body and two or more mating portions protruding forward into the mating cavity, the base portion defines a holding groove fixed to the insulative housing, each mating portion has a centerline parallel to the insertion direction and a guide hole communicates with the holding groove, the contacting portion of the conductive terminal extends into the guide hole.

### CROSS-REFERENCE TO RELATED APPLICATIONS

This present disclosure is a continuation application of International Application No. PCT/CN2023/129208, filed on Nov. 2, 2023, which claims priority to Chinese Patent Application No. 202211561261.1, 202223271994. X and 202223271258.4, filed on Dec. 6, 2022, with the Chinese Patent Office, and Chinese Patent Application No. 202320825826.6, 202320838561.3 and 202310397356.2, filed on Apr. 13, 2023, with the Chinese Patent Office, the disclosures of which are incorporated herein by reference in their entireties.

### TECHNICAL FIELD

The present disclosure relates to a vehicle connector, and more particularly to a vehicle connector applied to automotive wiring harnesses.

### BACKGROUND

Gradually integrating HF systems (GPS, external antennas for mobile radios, car radios, etc.) in the automotive industry requires the arrangement and connection of coaxial cables for these systems in cars. Introduce a standard for the automotive plug-in connectors in the USA and Europe to ensure compatibility between systems from different suppliers. For example, the United States has the SAE/USCAR-18 standard, Europe has the DIN 72594-1 (FAKRA) standard, and so on. Among them, FAKRA is the acronym for FAchKReis Automobile, defined by the Motor Vehicle Standards Committee.

Refer to the Chinese Invention Patent Application Publication No. 114914759 published on Aug. 16, 2022, the title of the invention is a small RF connector, which includes a cable segment module. The cable segment module at least includes a first housing and a first sleeve installed on the first housing, the first sleeve is assembled and combined with the first housing, during the assembly process, the first sleeve and the first housing will be tilted, or when the first sleeve involves multiple sleeves, it is difficult to ensure that the coaxiality of the multiple first sleeves is parallel to each other. Therefore, when the small RF connector is inserted into the mating connector, achieving stable docking after aligning the terminals in one sleeve can cause the terminals in the other sleeve to not be reliably mated, leading to unstable insertion and other phenomena. At the same time, it can also damage the terminals of the small RF connector, affecting its service life. If poor contact occurs with the connectors in the car, it can cause safety accidents. In addition, this assembly method increases manufacturing costs, and the strength is not enough.

The welding pins of the front and rear terminals of said RF connector are relatively close, which can easily cause signal interference and affect signal transmission. The first sleeve is equipped with an insulating body and a terminal, and the contacting portion of the terminal protrudes into the first sleeve to connect with the mating connector. Due to the close distance between the contacting portion of the terminal and the front end face of the first sleeve, when the mating connector is inserted, the terminal is connected to the mating connector before the first sleeve is aligned (i.e. not inserted parallel). The mating connector is prone to squeezing and deforming the contacting portion, making it impossible to achieve docking and affecting the docking effect of the two connectors.

Hence, a new vehicle connector is desired to improve those disclosed in the aforementioned proposal.

### SUMMARY OF THE INVENTION

Accordingly, the object of the present disclosure is a vehicle connector used for plugging in a mating connector, the vehicle connector includes a mounting body, a mating body and a plurality of terminal portions fixed on the mounting body; the mating portion has a mating cavity that runs through front and back, a front end of the mating body used for the mating connector pass through and inserted into the mating cavity, and a rear end of the mating body fixed on the mounting body; each terminal portion includes an insulative housing and a conductive terminal disposed in the insulative housing, the conductive terminal defines a retaining portion fixed in the insulative housing, a contacting portion extending from one end of the retaining portion and protruding out of the insulative housing, and a connecting pin extending from the other end of the retaining portion to the outside of the insulative housing; wherein the mounting body defines a base portion for fixing the mating body and two or more mating portions formed integrally with the base portion and protruding forward into the mating cavity of the mating body, the base portion defines a holding groove fixed to the insulative housing, each mating portion has a centerline parallel to the insertion direction and a guide hole communicates with the holding groove, the contacting portion of the conductive terminal extends into the guide hole.

Accordingly, the object of the present disclosure is a vehicle connector used for plugging in a mating connector, the vehicle connector includes a mounting body and a plurality of terminal portions fixed on the mounting body, each terminal portion includes an insulative housing and a conductive terminal disposed in the insulative housing, the conductive terminal defines a retaining portion fixed in the insulative housing, a contacting portion extending from one end of the retaining portion and protruding out of the insulative housing, and a connecting pin extending from the other end of the retaining portion to the outside of the insulative housing; wherein the mounting body defines a base portion and a plurality of mating portions formed integrally with the base portion and protruding forward into the mating cavity of the mating body, the base portion defines a holding groove fixed to the insulative housing, the holding groove has a centerline extending along the insertion direction of the terminal portion, each mating portion has a centerline parallel to the insertion direction and a guide hole communicates with the holding groove, the contacting portion of the conductive terminal extends into the guide hole, and the centerline of the holding groove coincides with the centerline of the mating portion.

Accordingly, the object of the present disclosure is a vehicle connector, used for plugging in a mating connector, the vehicle connector includes a mounting body made of metal materials and a plurality of terminal portions including a first terminal portion and a second terminal portion; the mounting body defines a base portion and a plurality of mating portions protruding forwardly from the base portion; each of the first terminal portion and the second terminal portion includes an insulative housing and a conductive terminal disposed in the insulative housing, the conductive terminal defines a retaining portion fixed in the insulative housing, a contacting portion extending from one end of the retaining portion and protruding out of the insulative housing, and a connecting pin extending from the other end of the retaining portion to the outside of the insulative housing; wherein the base portion has an insert slot, the vehicle connector includes a shielding plate inserted into the insert slot of the mounting body, and the shielding plate is located between the connecting pin of the first terminal portion and the connecting pin of the second terminal portion.

Accordingly, the object of the present disclosure is a vehicle connector, used for plugging in a mating connector, the vehicle connector includes a mounting body, a mating body and a plurality of terminal portions fixed on the mounting body; the mating portion has a mating cavity that runs through front and back, a front end of the mating body used for the mating connector pass through and inserted into the mating cavity, and a rear end of the mating body fixed on the mounting body; each terminal portion includes an insulative housing and a conductive terminal disposed in the insulative housing, the conductive terminal defines a retaining portion fixed in the insulative housing, a contacting portion extending from one end of the retaining portion and protruding out of the insulative housing, and a connecting pin extending from the other end of the retaining portion to the outside of the insulative housing; wherein the mounting body defines a base portion for fixing the mating body and a plurality of mating portions formed integrally with the base portion and protruding forward into the mating cavity of the mating body, the base portion defines a holding groove fixed to the insulative housing, each mating portion has a guide hole communicates with the holding groove, the contacting portion of the conductive terminal extends into the guide hole; wherein the distance between the front edge of the mating portion and the end of the contacting portion of the conductive terminal is at least greater than 1.10 millimeters, so that the guide hole can fully guide the insertion between the mating connector and the contacting portion of the conductive terminal.

Other objects, advantages and novel features of the disclosure will become more apparent from the following detailed description when taken in conjunction with the accompanying drawings.

### BRIEF DESCRIPTION OF THE DRAWINGS

FIG. 1 is a perspective view of a vehicle connector in accordance with the present invention;

FIG. 2 is another perspective view of the vehicle connector of FIG. 1, which shows the rear end;

FIG. 3 is a partially exploded perspective view of the vehicle connector of FIG. 1;

FIG. 4 is an exploded perspective view of the mounting body, cables and other components in the vehicle connector of FIG. 1;

FIG. 5 is another perspective view of the mating body in the vehicle connector of FIG. 1;

FIG. 6 is another perspective view of the vehicle connector of FIG. 1, which shows the mounting seat;

FIG. 7 is a cross-sectional view of the vehicle connector taken along line 7-7 of FIG. 1;

FIG. 8 is a front perspective view of the vehicle connector of FIG. 1;

FIG. 9 is a cross-sectional view of the vehicle connector taken along line 9-9 of FIG. 2; and

FIG. 10 is a cross-sectional view of the vehicle connector taken along line 10-10 of FIG. 8.

### DETAILED DESCRIPTION

Reference will now be made in detail to the preferred embodiment of the present disclosure.

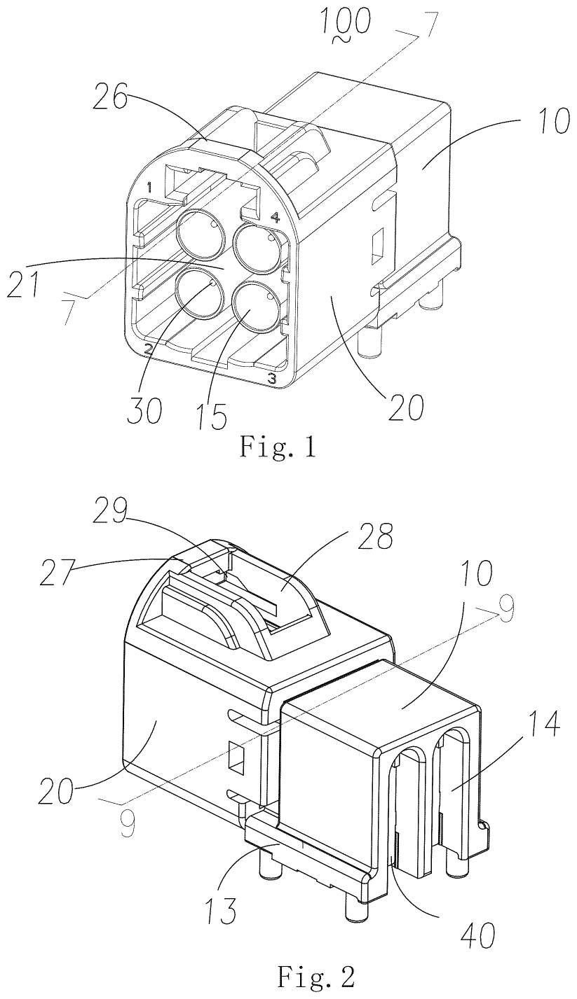

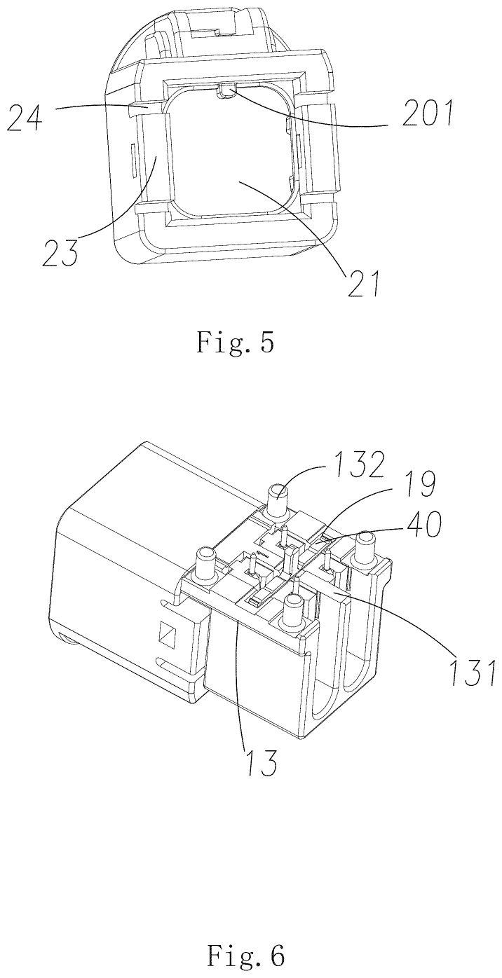

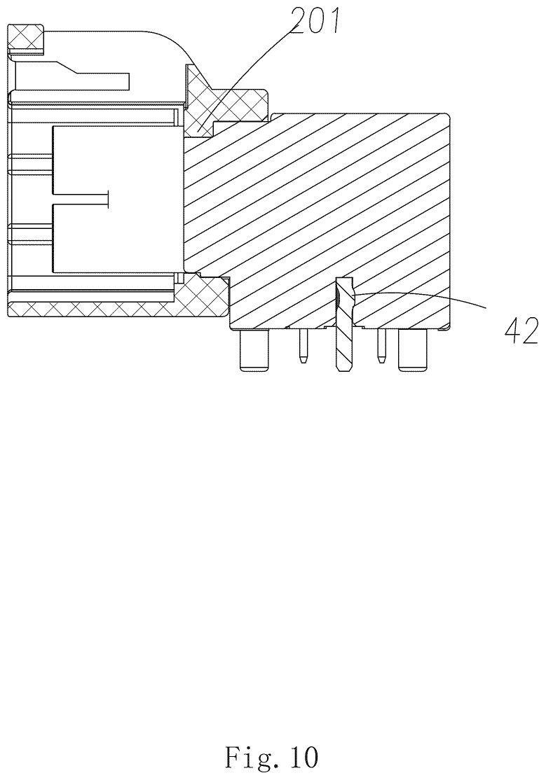

FIG. 1 to FIG. 10 show a vehicle connector 100 in a preferred embodiment of the present invention, and the vehicle connector 100 includes a mounting body 10, a mating body 20 fixed on the mounting body 10, a plurality of terminal portions 30 and a shielding plate 40 retained in the mounting body 10. The vehicle connector 100 is used for plugging in a mating connector to achieve signal transmission.

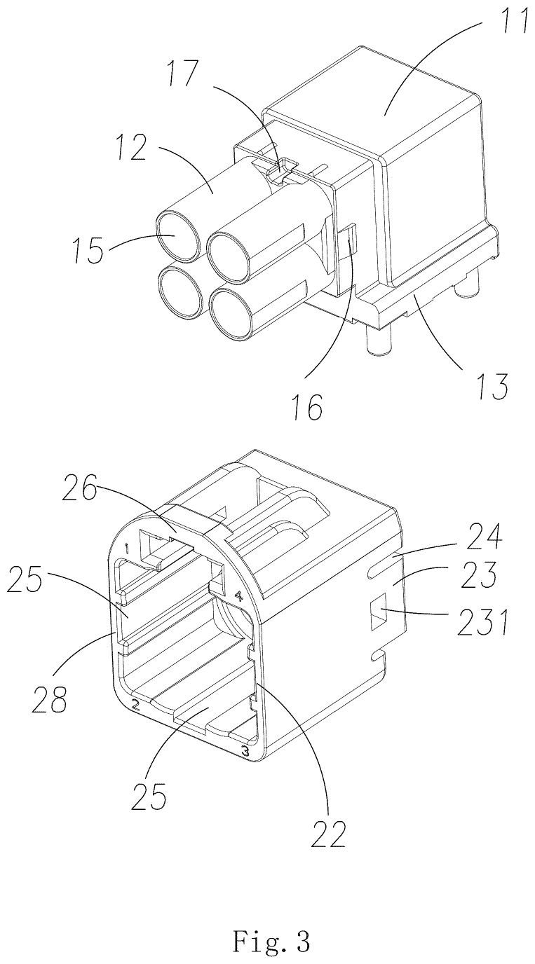

Refer to FIG. 3 and FIG. 6, in this embodiment, the mounting body 10 is integrally formed by die-casting metal materials, of course, the mounting body 10 can also be formed by other methods, such as powder metal injection molding, etc. The mounting body 10 defines a base portion 11 for fixing the mating body 20 and two or more mating portions 12 formed integrally with the base portion 11 and protruding forward into the mating cavity 21 of the mating body 20. The base portion 11 defines a mounting seat 13 located at the lower end and a holding groove 14 fixed to the terminal portion 30. Each of the mating portions 12 has a centerline 120 parallel to the insertion direction and a guide hole 15 communicates with the holding groove 14, the centerline 120 of each mating portion 12 is parallel to the centerline 120 of another mating portion 12.

In the present invention, the base portion 11 and several mating portions 12 are integrally formed, that is, the mounting body 10 is molded in a mold at one time, which can ensure the molding stability of several mating portions 12, that is, the positional degree or coaxiality of the several mating portions is consistent. That is to say, the centerlines 120 of the mating portions 12 are parallel to each other. Of course, it can also be understood that the holding groove 14 has a centerline extending along the insertion direction of the terminal portion 30, and the centerline of the holding groove 14 coincides with the centerline 120 of the mating portion 12 to facilitate accurate insertion of the mating connector, prevent oblique insertion or damage to the contacting portion 34 of the conductive terminal 32, and ensure reliable docking. In particular, the vehicle connector 100 of the present invention is used in the automotive field and often involves plugging and unplugging phenomenon, and it is also ensured that the contacting portion 34 of the conductive terminal 32 has reliable contact and will not have poor contact, so as to protect the safety of life and property. The centerline of the holding groove 14 should be understood as the centerline of the part where the contacting portion 34 of the conductive terminal 32 extends backwards towards the insulative housing 31, the holding groove 14 may have various variations, but at least a part of the centerline of the contacting portion 34 of the conductive terminal 32 extending backwardly and accommodated in the holding groove 14 is the centerline defined above.

The mating portions 12 are located above the bottom surface 131 of the mounting seat 13, and the mounting seat 13 has four positioning posts 132 protruding downwardly and respectively located at the four corners of the mounting seat 13, so as to accurately install the mounting body 10 on a circuit board.

The mating body 20 is made of insulating material and has a mating cavity 21 that runs through front and back. The front end of the mating body 20 is used for the mating connector pass through and inserted into the mating cavity 21 to form a docking connection and locking the mating connector. The rear end of the mating body 20 is fixed on the mounting body 10 to combine the mounting body 10 with the mating body 20, which will be described in detail later. In this embodiment, the mating body 20 has two side walls 22 located on both sides of the mating cavity 21, each side wall 22 defines a locking portion 23 located on the rear side thereof, a pair of narrow slots 24 on both sides of the locking portion 23 and several guide slots 25 located on the inner side thereof, each locking portion 23 defines a locking hole 231 running through the side wall 22.

The mating body 20 has a locking part 26 located on the upper side of the mating cavity 21 to lock the mating connector, thereby preventing accidental detachment of the mating connector, which may cause safety hazards to the vehicle during operation. The locking part 26 has a front wall 27, a reinforcing wall 28 extending backwardly from both sides of the front wall 27, and a locking groove 29 located between the reinforcing walls 28, the locking groove 29 is communicated to the mating cavity 21. Among them, the reinforcing wall 28 can improve the strength of the locking part 26, which can ensure that the locking part 26 is firmly connected to the mating connector under pulling condition. Especially when the car is driving at high speed or on uneven roads, the reinforcing wall 28 of the locking part 26 is particularly important.

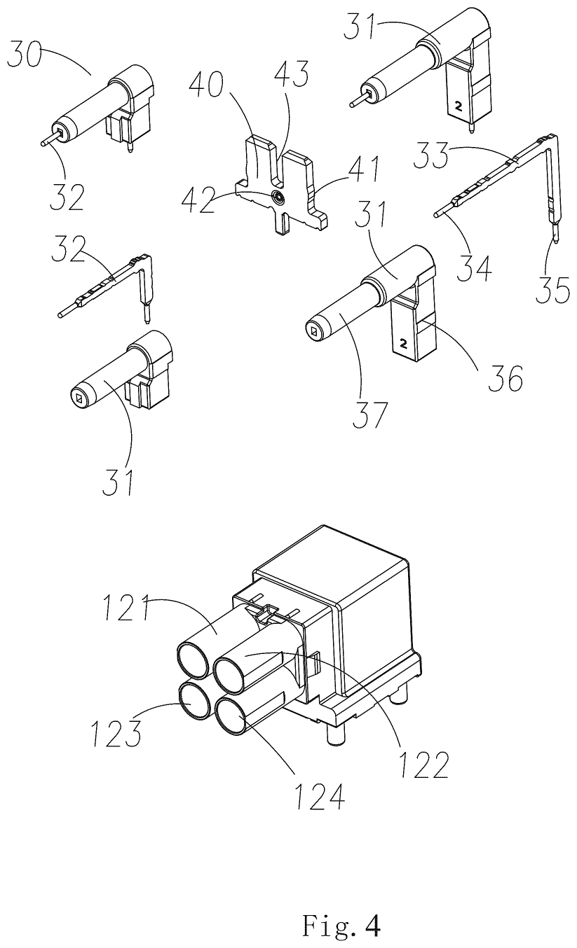

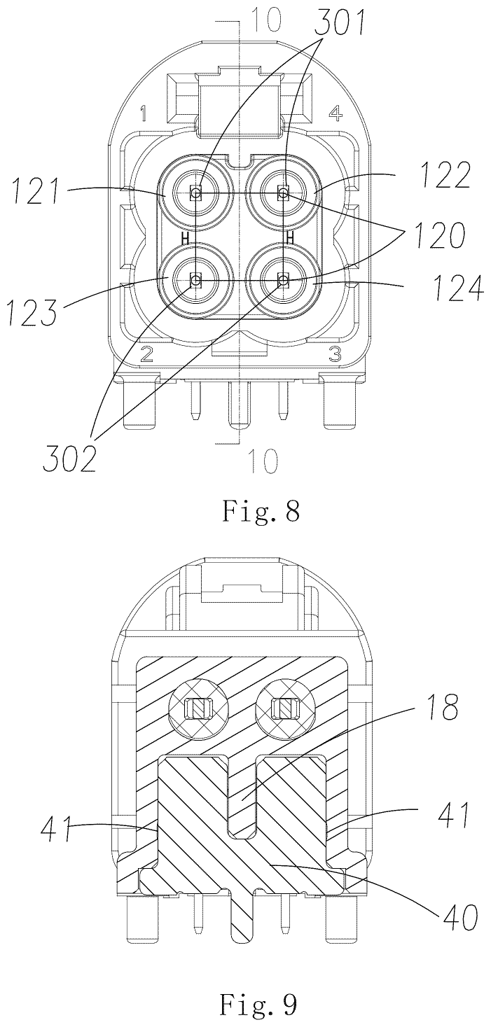

Refer to FIG. 4 and FIG. 8, each of the terminal portions 30 includes an insulative housing 31 and a conductive terminal 32 disposed in the insulative housing 31, the conductive terminal 32 defines a retaining portion 33 fixed in the insulative housing 31, a contacting portion 34 extending from one end of the retaining portion 33 and protruding out of the insulative housing 31, and a connecting pin 35 extending from the other end of the retaining portion 33 to the outside of the insulative housing 31, and the contacting portion 34 of the conductive terminal 32 extends into the guide hole 15.

The insulative housing 31 includes a rear seat 36 and a supporting body 37 protruding forward from the rear seat 36, the rear seat 36 is fixed with the supporting body 37 in the holding groove 14 of the mounting body 10, and the front end 38 of the supporting body 37 protrudes into the guide hole 15. The contacting portion 34 of the conductive terminal 32 protrudes from the front end 38 of the supporting body 37 and protrudes into the guide hole 15. In this embodiment, the front end 38 of the supporting body 37 is configured as a tapered surface, so as to guide the mating connector to be positioned and docked.

In this embodiment, the retaining portion 33 of the conductive terminal 32 has a first connecting portion 331 connected to the contacting portion 34 and a second connecting portion 332 connected to the first connecting portion 331, the first connecting portion 331 is perpendicular to the second connecting portion 332, and the connecting pin 35 is connected to the end of the second connecting portion 332. The first connecting portion 331 and the second connecting portion 332 are arranged perpendicular to each other, which is conducive to the insertion and positioning of the conductive terminal 32 within the mounting body 10.

Refer to FIG. 3, the mounting body 10 has a clamping portion 16 protruding outward, and the locking hole 231 of the mating body 20 is clamped on the clamping portion 16. In addition, the base portion 11 defines a positioning groove 17 adjacent to the mating portions 12 to position and accommodate the protrusion 201 of the mating body 20. Therefore, on the one hand, the mating body 20 is positioned and inserted into the mounting body 10, and on the other hand, the mating body 20 is held on the mounting body 10. Several above-mentioned mating portions 12 are arranged at intervals, and the middle space is convenient for the plastic of the mating connector insertion, in addition, the above-mentioned positioning groove 17 is located between two mating portions 12.

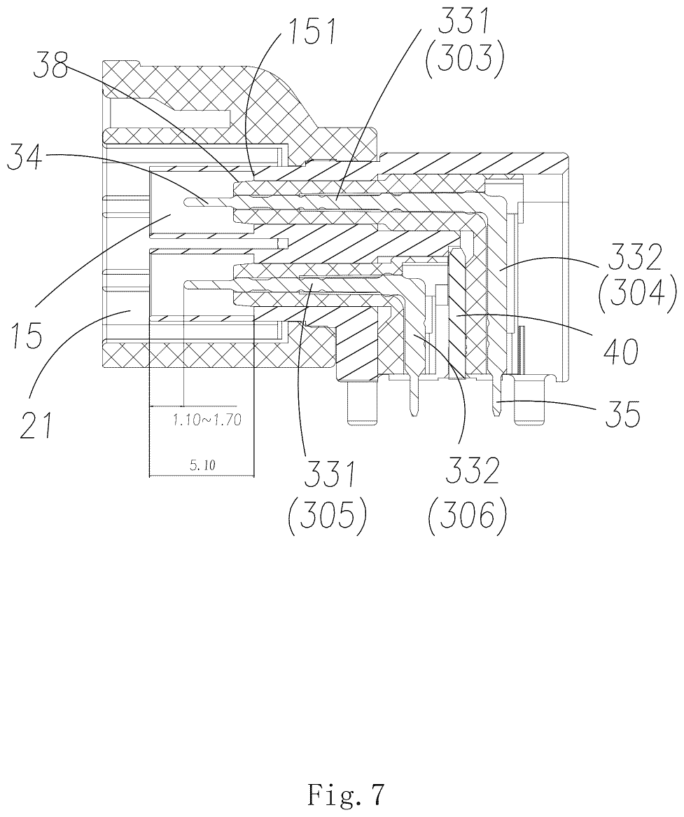

Refer to FIG. 4, FIG. 7 and FIG. 8, in this embodiment, the mating portions 12 have at least four arrangements 121, 122, 123, 124, and are arranged side by side. Of course, the mating portions 12 can also be provided with multiple settings such as 2, 3, 5, 6, 7, 8, etc., due to the mounting body 10 is integrally formed, i.e. the mating portions 12 and the base portion 11 are integrally formed to ensure the bonding strength between the mating portions 12 and the base portion 11, and also improve the concentricity (also known as positional degree) of the mating portions 12. That is, the centerline 120 of each mating portion 12 is parallel to the centerline of the adjacent mating portion 12, or it can be understood that the centerline 120 of the guide hole 15 is parallel to each other, or that the centerline of the holding groove 14 coincides with the centerline 120 of the mating portion 12 (as shown in FIG. 8 and FIG. 9), ensuring that the mating portion 12 is consistent with the holding groove 14 during molding, so as to facilitate accurate insertion of the mating connector, prevent oblique insertion or damage to the contacting portion 34 of the conductive terminal 32, and ensure reliable docking. Especially when plugging and unplugging multiple times, the contacting portion 34 of the conductive terminal 32 is also reliably connected, and there will be no poor contact phenomenon when re-plugging. The present invention ensures that the centerlines of several mating portions 12 are arranged in parallel through the above-mentioned integrated forming structure, and the contacting portions 34 installed in the guide holes 15 of the mating portions 12 are also kept parallel to each other, which increases the reliability of docking and is conducive to ensuring reliable contact during the driving process of the car, to prevent the increased probability of accidents caused by poor contact, so as to protect the safety of life and property.

Refer to FIG. 4 and FIG. 8, in this embodiment, the terminal portions 30 include a first terminal portion 301 and a second terminal portion 302, and each of the first terminal portion 301 and the second terminal portion 302 include an insulative housing 31 and a conductive terminal 32 placed within the insulative housing 31. The conductive terminal 32 has a retaining portion 33 fixed in the insulative housing 31, a contacting portion 34 protruding from one end of the retaining portion 33 out of the insulative housing 31, and a connecting pin 35 extending from the other end of the retaining portion 33 and projecting outside of the insulative housing 31, and the contacting portion 34 of the conductive terminal 32 extends into the guide hole 15. The above-mentioned shielding plate 40 is located between the connecting pin 35 of the first terminal portion 301 and the connecting pin 35 of the second terminal portion 302. Compared with the prior art, it is conducive to improving the signal interference resistance between the first terminal portion 301 and the second terminal portion 302, and improving the transmission efficiency between the vehicle connector 100 and the mating connector. Especially in the field of autonomous driving, anti-interference is particularly important.

Of course, in this embodiment, the mating portions 12 are arranged side by side, and the retaining portion 33 of the first terminal portion 301 has an outer first connecting portion 303 connected to the contacting portion 34 and an outer second connecting portion 304 connected to the outer first connecting portion 303, the outer first connecting portion 303 is perpendicular to the outer second connecting portion 304, and the connecting pin 35 is connected to the end of the outer second connecting portion 304. The retaining portion 33 of the second terminal portion 302 has an inner first connecting portion 305 connected to the contacting portion 34 and an inner second connecting portion 306 connected to the inner first connecting portion 305, the inner first connecting portion 305 is perpendicular to the inner second connecting portion 306, and the connecting pin 35 is connected to the end of the inner second connecting portion 306. The shielding plate 40 is located between the outer second connecting portion 304 and the inner second connecting portion 306, the mounting body 10 has an insert slot 19 for accommodating the shielding plate 40 to improve signal interference resistance between the outer second connecting portion 304 and the inner second connecting portion 306, and to enhance transmission efficiency. Therefore, in combination with the above description, the outer first connecting portion 303 and the inner first connecting portion 305 are collectively referred to as the first connecting portion 331, the outer second connecting portion 304 and the inner second connecting portion 306 are collectively referred to as the second connecting portion 332.

In this embodiment, the shielding plate 40 is in the shape of a flat plate, which has a pair of barbs 41 located on both sides thereof, a projecting portion 42 protruding towards one side thereof and a clamping groove 43. The force directions of the barbs 41 and the projecting portion 42 on the mounting body 10 are perpendicular to each other, and the shielding plate 40 is stably fixed on the mounting body 10 through multi-directional positioning effects. The rear seat 36 extends downward perpendicular to the supporting body 37 and abuts against the mounting body 10 or the shielding plate 40 to determine the positioning of the terminal portion 30 installed inside the mounting body 10, the clamping groove 43 accommodates the fixing wall 18 of the mounting body 10. Furthermore, the shielding plate 40 of the present invention is formed by stamping, which facilitates the forming of the barbs 41, the projecting portion 42 and the clamping groove 43, and also reduces the manufacturing cost.

In this embodiment, the distance from the front edge of the mating portion 12 to the inner surface 151 of the guide hole 15 is 5.1 millimeters to fully insert the mating connector, and the distance between the front edge of the mating portion 12 and the end of the contacting portion 34 of the conductive terminal 32 is at least greater than 1.10 millimeters, so that the guide hole 15 can fully guide the insertion of the mating connector. By ensuring the mating length of the mating portion 12, the contact length of the mating connector in the guide hole 15 can also be increased, and then it can be mated with the contacting portion 34 of the conductive terminal 32 to prevent excessive docking between the mating connector and the contacting portion 34 of the conductive terminal 32, thereby avoiding the risk of deformation caused by compression of the contacting portion 34.

In this embodiment, the distance between the front edge of the mating portion 12 and the end of the contacting portion 34 of the conductive terminal 32 does not exceed 1.70 millimeters, so as to prevent the contacting portion from being too short, which may affect the contact effect. In compliance with international standards, this improves the stability and contact reliability of the vehicle connector 100 in conjunction with the mating connector. Moreover, in high-frequency connectors, the higher the frequency, the more obvious the transmission of electromagnetic wave signals from the surface of the conductor. Therefore, the insertion depth of the contacting portion 34 of the conductive terminal 32 is too deep, which not only does not have too many benefits, but also increases the manufacturing cost of the connector, so the present invention only needs to keep the contacting portion 34 in contact with the mating connector when the mating portion 12 can be fully inserted, so as to achieve cost reduction and better maintain contact and signal transmission.

Therefore, the guide hole 15 can fully guide the mating connector, that is, the guide hole 15 can directly connect the contacting portion 34 of the conductive terminal 32 and the mating connector. Compared with the existing connector, the mating connector can be guided to be inserted in the guide hole 15 for a long time to prevent the mating connector from being obliquely inserted, to achieve parallel insertion of the mating connection relative to the contacting portion 34 of the conductive terminal 32, and prevent deformation of the conductive terminal 32 due to compression. Furthermore, the base portion 11 and the mating portions 12 are integrally formed, and the mating portion 12 has no gaps so that the mating portion 12 has a better shielding effect than the existing connector formed by stamping and bending technology.

However, the disclosure is illustrative only, changes may be made in detail, especially in matter of shape, size, and arrangement of parts within the principles of the disclosure.

What is claimed is:

1. A vehicle connector, used for plugging in a mating connector, comprising:
a mounting body;
a mating body fixed on the mounting body, the mating portion having a mating cavity that runs through front and back, a front end of the mating body used for the mating connector pass through and inserted into the mating cavity, and a rear end of the mating body fixed on the mounting body; and
a plurality of terminal portions fixed on the mounting body, each terminal portion including an insulative housing and a conductive terminal disposed in the insulative housing, the conductive terminal defining a retaining portion fixed in the insulative housing, a contacting portion extending from one end of the retaining portion and protruding out of the insulative housing, and a connecting pin extending from the other end of the retaining portion to the outside of the insulative housing;
wherein the mounting body defines a base portion for fixing the mating body and two or more mating portions formed integrally with the base portion and protruding forward into the mating cavity of the mating body, the base portion defines a holding groove fixed to the insulative housing, each mating portion has a centerline parallel to the insertion direction and a guide hole communicates with the holding groove, the contacting portion of the conductive terminal extends into the guide hole.

2. The vehicle connector according to claim 1, wherein the centerline of each mating portion is parallel to the centerline of another mating portion, and the centerlines of the mating portions are parallel to the insertion direction, respectively.

3. The vehicle connector according to claim 1, wherein the retaining portion of the conductive terminal has a first connecting portion connected to the contacting portion and a second connecting portion connected to the first connecting portion, the first connecting portion is perpendicular to the second connecting portion, and the connecting pin is connected to the end of the second connecting portion.

4. The vehicle connector according to claim 1, wherein the terminal portions include a first terminal portion and a second terminal portion, the retaining portion of the first terminal portion has an outer first connecting portion connected to the contacting portion and an outer second connecting portion connected to the outer first connecting portion, the outer first connecting portion is perpendicular to the outer second connecting portion, and the connecting pin is connected to the end of the outer second connecting portion, the retaining portion of the second terminal portion has an inner first connecting portion connected to the contacting portion and an inner second connecting portion connected to the inner first connecting portion, the inner first connecting portion is perpendicular to the inner second connecting portion, and the connecting pin is connected to the end of the inner second connecting portion, the vehicle connector includes a shielding plate retained in the mounting body, the shielding plate is located between the outer second connecting portion and the inner second connecting portion, the mounting body has an insert slot for accommodating the shielding plate.

5. The vehicle connector according to claim 4, wherein the insulative housing includes a rear seat and a supporting body protruding forward from the rear seat, the rear seat is fixed with the supporting body in the holding groove of the mounting body, and the front end of the supporting body protrudes into the guide hole, the contacting portion of the conductive terminal protrudes from the front end of the supporting body and protrudes into the guide hole.

6. The vehicle connector according to claim 5, wherein the front end of the supporting body is configured as a tapered surface, so as to guide the mating connector to be positioned and docked.

7. The vehicle connector according to claim 5, wherein the rear seat extends downward perpendicular to the supporting body and abuts against the mounting body or the shielding plate.

8. The vehicle connector according to claim 1, wherein the distance from the front edge of the mating portion to the inner surface of the guide hole is 5.1 millimeters to fully insert the mating connector, and the distance between the front edge of the mating portion and the end of the contacting portion of the conductive terminal is at least greater than 1.10 millimeters, so that the guide hole can fully guide the insertion of the mating connector.

9. The vehicle connector according to claim 1, wherein the base portion defines a mounting seat located at the lower end thereof, the mating portions are located above the bottom surface of the mounting seat, and the mounting seat has four positioning posts protruding downwardly and respectively located at the four corners of the mounting seat.

10. The vehicle connector according to claim 1, wherein the mating body defines a protrusion projecting into the mating cavity, the base portion defines a positioning groove adjacent to the mating portions to position and accommodate the protrusion of the mating body.

11. The vehicle connector according to claim 1, wherein the mating body has a locking part located on the upper side of the mating cavity, the locking part has a front wall, a reinforcing wall extending backwardly from both sides of the front wall, and a locking groove located between the reinforcing walls, the locking groove is communicated to the mating cavity.

12. The vehicle connector according to claim 11, wherein the mating body has two side walls located on both sides of the mating cavity, each side walls defines a locking portion located on the rear side thereof and a pair of narrow slots on both sides of the locking portion, the locking portion defines a locking hole running through the side wall, the mounting body has a clamping portion protruding outward, and the locking hole of the mating body is clamped on the clamping portion.

13. The vehicle connector according to claim 1, wherein the holding groove has a centerline extending along the insertion direction of the terminal portion, and the centerline of the holding groove coincides with the centerline of the mating portion.

14. The vehicle connector according to claim 13, wherein the mating portions have three or more arrangements, and the centerline of each mating portion has the same positional degree as the centerline of adjacent mating portion.

15. A vehicle connector, used for plugging in a mating connector, comprising:
a mounting body made of metal materials, the mounting body defining a base portion and a plurality of mating portions protruding forwardly from the base portion; and
a plurality of terminal portions including a first terminal portion and a second terminal portion, each of the first terminal portion and the second terminal portion including an insulative housing and a conductive terminal disposed in the insulative housing, the conductive terminal defining a retaining portion fixed in the insulative housing, a contacting portion extending from one end of the retaining portion and protruding out of the insulative housing, and a connecting pin extending from the other end of the retaining portion to the outside of the insulative housing;
wherein the base portion has an insert slot, the vehicle connector includes a shielding plate inserted into the insert slot of the mounting body, and the shielding plate is located between the connecting pin of the first terminal portion and the connecting pin of the second terminal portion.

16. The vehicle connector according to claim 15, wherein the shielding plate is in the shape of a flat plate, which has a pair of barbs located on both sides thereof and a projecting portion protruding towards one side thereof, the force directions of the barbs and the projecting portion on the mounting body are perpendicular to each other.

17. The vehicle connector according to claim 15, wherein the mating portions have at least four arrangements and are arranged side by side, the retaining portion of the first terminal portion has an outer first connecting portion connected to the contacting portion and an outer second connecting portion connected to the outer first connecting portion, the outer first connecting portion is perpendicular to the outer second connecting portion, and the connecting pin is connected to the end of the outer second connecting portion, the retaining portion of the second terminal portion has an inner first connecting portion connected to the contacting portion and an inner second connecting portion connected to the inner first connecting portion, the inner first connecting portion is perpendicular to the inner second connecting portion, and the connecting pin is connected to the end of the inner second connecting portion, the shielding plate is located between the outer second connecting portion and the inner second connecting portion.

18. A vehicle connector, used for plugging in a mating connector, comprising:
a mounting body;
a mating body fixed on the mounting body, the mating portion having a mating cavity that runs through front and back, a front end of the mating body used for the mating connector pass through and inserted into the mating cavity, and a rear end of the mating body fixed on the mounting body; and
a plurality of terminal portions fixed on the mounting body, each terminal portion including an insulative housing and a conductive terminal disposed in the insulative housing, the conductive terminal defining a retaining portion fixed in the insulative housing, a contacting portion extending from one end of the retaining portion and protruding out of the insulative housing, and a connecting pin extending from the other end of the retaining portion to the outside of the insulative housing;
wherein the mounting body defines a base portion for fixing the mating body and a plurality of mating portions formed integrally with the base portion and protruding forward into the mating cavity of the mating body, the base portion defines a holding groove fixed to the insulative housing, each mating portion has a guide hole communicates with the holding groove, the contacting portion of the conductive terminal extends into the guide hole;
wherein the distance between the front edge of the mating portion and the end of the contacting portion of the conductive terminal is at least greater than 1.10 millimeters, so that the guide hole can fully guide the insertion between the mating connector and the contacting portion of the conductive terminal.

19. The vehicle connector according to claim 18, wherein he distance between the front edge of the mating portion and the end of the contacting portion of the conductive terminal does not exceed 1.70 millimeters.

20. The vehicle connector according to claim 18, wherein the base portion and the mating portions are integrally formed by metal materials, and the mating portions are arranged at intervals.
